(19) United States
(12) Patent Application Publication
(10) Pub. No.: US 2022/0038422 A1
(43) Pub. Date: Feb. 3, 2022

(54) AUTHENTICATION AND FIREWALL ENFORCEMENT FOR INTERNET OF THINGS (IOT) DEVICES

(71) Applicant: Hewlett Packard Enterprise Development LP, Houston, TX (US)

(72) Inventors: Hao LU, Fremont, CA (US); Berend DUNSBERGEN, San Jose, CA (US); Xiaoding SHANG, Beijing (CN); Yafeng JIANG, Beijing (CN)

(21) Appl. No.: 16/944,671

(22) Filed: Jul. 31, 2020

(51) Int. Cl. H04L 29/06; H04L 12/46; H04L 29/12

(52) U.S. Cl. CPC H04L 63/0218; H04L 61/2015; H04L 12/4641; H04L 63/0876

(57) ABSTRACT

Examples of authentication and firewall enforcement for Internet of Things (IoT) devices are described. In an example, a request to authenticate an IoT device coupled to a network device is sent to an authentication server. The request includes a Media Access Control (MAC) address of the IoT device. A response indicative of successful authentication of the IoT device based on the MAC address is received from the authentication server. The response includes a first attribute indicative of a network address of a remote server to connect with the IoT device. A firewall role for the IoT device is generated based on a combination of an Internet Protocol (IP) address of the IoT device and the first attribute. The IoT device is associated with the firewall role.

### BACKGROUND

A computer network includes a variety of network devices, such as access points, controllers, gateways, switches, etc., which perform different networking operations, such as network access, authentication, and routing network traffic to provide connectivity. A Wireless Local Area Network (WLAN) may include a plurality of Access Points (APs), as elements of the WLAN. These APs may be deployed in the network.

The explosion and proliferation of wireless-networked electronic devices in everything from inventory tags to appliances has led to increasing demand for small, smart, battery-powered devices. These devices, often referred to collectively as “Internet of Things” (IoT), currently employ network protocols such as Bluetooth Low Energy (BLE), Zigbee, and the like. The IoT devices may be attached to a network device that operates through the internet, enabling the transfer of data among the IoT devices and other devices connected over the network.

### BRIEF DESCRIPTION OF DRAWINGS

The present disclosure, in accordance with one or more various embodiments, is described in detail with reference to the following figures. The figures are provided for purposes of illustration only and merely depict typical or example embodiments.

FIG. 1 illustrates an example of a network configuration that may be implemented for an organization, such as a business, educational institution, governmental entity, healthcare facility or other organization.

FIG. 2 is a block diagram of an example computing component or device for authentication and firewall enforcement for an IoT device, in accordance with an embodiment.

FIG. 3 illustrates an example method for authentication and firewall enforcement for an IoT device, in accordance with an embodiment in accordance with an embodiment.

FIG. 4 depicts a block diagram of an example computer system in which the embodiments described herein may be implemented.

The figures are not exhaustive and do not limit the present disclosure to the precise form disclosed.

### DETAILED DESCRIPTION

The IoT devices may be integrated with a WLAN infrastructure by connecting the IoT devices with network devices, such as APs. Generally, IoT vendors have built-in IoT radios within a small Universal Serial Bus (USB) dongle device, also called an IoT dongle device. These IoT dongle devices (also referred to as IoT devices) can connect to respective IoT sensors via standard protocols, such as Zigbee, BLE, etc. These IoT devices can be plugged into network devices, such as access points or network controllers, via USB ports of the network devices. By connecting to the network devices, the IoT devices may access an Internet Protocol (IP) network and exchange data packets with remote servers, such as IoT servers or cloud servers over the IP network.

Generally, a network device includes a USB driver which provides interoperability between an IoT device and the network device once the IoT device is attached to a USB port of the network device. The USB driver may refer to a file that enables hardware USB devices, such as IoT devices, to communicate with the operating system of the network device. The USB driver for the IoT devices may include an approved list of Identification Numbers, such as “Vendor ID & Produce ID” of IoT devices which are allowed to successfully connect to the network device. “Vendor ID and Produce ID” refers to one or more identification numbers associated with an IoT device and may be defined by IoT vendors manufacturing the IoT device. When an IoT device is coupled to a network device via a USB port of the network device, authentication of the IoT device is generally performed based on a validation of the “Vendor ID & Produce ID” of the IoT device. In an example, the “Vendor ID and Produce ID” may be extracted by the USB driver and matched with the approved list of “Vendor ID & Produce ID” maintained in the USB driver.

Often IoT vendors launch newer versions of IoT devices having different identification numbers/tags. Also, in some examples, the newer versions of the IoT devices may have different types or forms of identification information embedded in them, instead of “Vendor ID and Produce ID”. When such newer version(s) of IoT devices are connected to a USB port of a network device, existing USB drivers of the network device may not be able to extract and validate the “Vendor ID and Produce ID” of such devices. Thus, in order to support these newer versions of IoT devices, there may be modifications required in the USB driver and Application Programming Interfaces (APIs) associated with the USB driver, such that the modified USB driver is able to extract and validate the identification information/tags of the newer versions of the IoT devices to allow network access for these devices. Further, in some examples, configuration changes in the IoT device itself may be required to obtain identification information for validation by the USB driver. Thus, with multiple newer versions of IoT devices, multiple modifications to the USB driver and associated APIs may be necessary, which may be complex, cumbersome, and time consuming.

Further, the IoT devices may be vulnerable to cyber-attacks and when connected to a network device which is part of a WLAN infrastructure, may also expose the WLAN infrastructure to such cyber-attacks. Thus, it is required to group IoT devices into separate Virtual Local Area Networks (VLANs) and restrict firewall roles for those IoT devices. However, configuring VLANs and firewall roles for such IoT devices may be complex. First, a VLAN needs to be manually pre-configured for the USB port of the network device to which the IoT device is to be connected. Then certain firewall roles may be manually configured for that USB port, to ensure that only specific traffic is allowed to and from the IoT device through the USB port. Since the configuration of the VLAN and the firewall role is associated with the USB port of the network device, if the network administrator wishes to connect the IoT device to a different USB port or a different network device, the VLAN & firewall role configuration changes needs to be repeated for the different port or device, consequently adding time and complexity in configuration. In a scenario, where multiple IoT devices are connected to different ports of a network device, multiple VLANs and firewall roles are required to be manually pre-configured on the network device, which may further increase complexity of configuring the network device.

The present disclosure involves a technique of authentication, automatic VLAN segmentation and firewall enforcement for an IoT device coupled to a network device. In an example of the present disclosure, the network device sends a Media Access Control (MAC)-based authentication request to an authentication server for authentication of the IoT device. Along with an authentication successful response, an attribute indicative of a network address of a remote server to connect with the IoT device is received by the network device. Based on a combination of an IP address of the IoT device and the attribute, a firewall role for the IoT device is generated and the IoT device is associated with the generated firewall role.

As explained above, in the present disclosure, authentication of the IoT device coupled to the network device is based on MAC address of the IoT device. Thus, with the techniques of the present disclosure, when newer version of an IoT device is connected to the network device, modification to the USB driver of the network device may not be required. Modifications may be limited to adding new MAC address entries to a database based on which the MAC-based authentication is performed by the authentication server of the present disclosure. Such addition of MAC address entries to the database are simpler and less cumbersome as compared to modifications to USB driver(s), associated APIs, or configuration changes in the IoT devices which are otherwise required. Also, the present disclosure enables automatic enforcement of the firewall role based on a combination of an Internet Protocol (IP) address of the IoT device and the network address of the remote server to connect with the IoT device. Generation of the firewall role and associating the firewall role with the IoT device, once the IoT device is connected to the network device, may allow to reduce/eliminate manually preconfiguring the USB ports of the network devices. Further, since in the present disclosure, the firewall role is associated with the IoT device itself, the same firewall role is generated and associated to the IoT device even if the IoT device is connected to a different port or to a different network device altogether. This provides additional flexibility in shifting the IoT devices between different USB ports of a network device or between different network devices, with reduced configuration changes to the ports or network devices.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

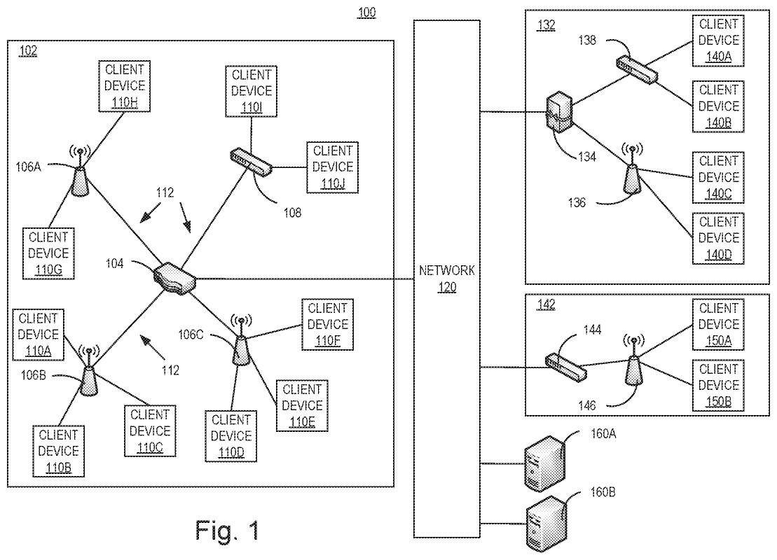

Before describing embodiments of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. This diagram illustrates an example of a configuration implemented with an organization having multiple users (or at least multiple client devices 110) and possibly multiple physical or geographical sites 102, 132, 142. The network configuration 100 may include a primary site 102 in communication with a network 120. The network configuration 100 may also include one or more remote sites 132, 142, that are in communication with the network 120.

The primary site 102 may include a primary network, which can be, for example, an office network, home network or other network installation. The primary site 102 network may be a private network, such as a network that may include security and access controls to restrict access to authorized users of the private network. Authorized users may include, for example, employees of a company at primary site 102, residents of a house, customers at a business, and so on.

In the illustrated example, the primary site 102 includes a controller 104 in communication with the network 120. The controller 104 may provide communication with the network 120 for the primary site 102, though it may not be the only point of communication with the network 120 for the primary site 102. A single controller 104 is illustrated, though the primary site may include multiple controllers and/or multiple communication points with network 120. In some embodiments, the controller 104 communicates with the network 120 through a router (not illustrated). In other embodiments, the controller 104 provides router functionality to the devices in the primary site 102.

The controller 104 may be operable to configure and manage network devices, such as at the primary site 102, and may also manage network devices at the remote sites 132, 134. The controller 104 may be operable to configure and/or manage switches, routers, access points, and/or client devices connected to a network. The controller 104 may itself be, or provide the functionality of, an access point.

The controller 104 may be in communication with one or more switches 108 and/or wireless Access Points (APs) 106a-c. Switches 108 and wireless APs 106a-c provide network connectivity to various client devices 110a-j. Using a connection to a switch 108 or AP 106a-c, a client device 110a-j may access network resources, including other devices on the (primary site 102) network and the network 120. In some examples, the controller 104 or the APs 106a-c may include a USB port for connecting to other devices.

Examples of client devices may include: desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, Internet of Things (IOT) devices, and the like. Client devices may also be referred to as stations (STA). In some examples, the client devices, such as IoT devices, may be coupled to the controller 104 or to the APs 106a-c via the USB port of the controller 104 or the APs 106a-c.

Within the primary site 102, a switch 108 is included as one example of a point of access to the network established in primary site 102 for wired client devices 110i-j. Client devices 110i-j may connect to the switch 108 and through the switch 108, may be able to access other devices within the network configuration 100. The client devices 110i-j may also be able to access the network 120, through the switch 108. The client devices 110i-j may communicate with the switch 108 over a wired 112 connection. In the illustrated example, the switch 108 communicates with the controller 104 over a wired 112 connection, though this connection may also be wireless.

Wireless APs 106a-c are included as another example of a point of access to the network established in primary site 102 for client devices 110a-h. The APs 106a-c may control network access of the client devices 110a-h and may authenticate the client devices 110a-h for connecting to the APs and through the APs, to other devices within the network configuration 100. Each of APs 106a-c may be a combination of hardware, software, and/or firmware that is configured to provide wireless network connectivity to wireless client devices 110a-h. In the illustrated example, APs 106a-c can be managed and configured by the controller 104. APs 106a-c communicate with the controller 104 and the network over connections 112, which may be either wired or wireless interfaces.

The network configuration 100 may include one or more remote sites 132. A remote site 132 may be located in a different physical or geographical location from the primary site 102. In some cases, the remote site 132 may be in the same geographical location, or possibly the same building, as the primary site 102, but lacks a direct connection to the network located within the primary site 102. Instead, remote site 132 may utilize a connection over a different network, e.g., network 120. A remote site 132 such as the one illustrated in FIG. 1 may be, for example, a satellite office, another floor or suite in a building, and so on. The remote site 132 may include a gateway device 134 for communicating with the network 120. A gateway device 134 may be a router, a digital-to-analog modem, a cable modem, a Digital Subscriber Line (DSL) modem, or some other network device configured to communicate to the network 120. The remote site 132 may also include a switch 138 and/or AP 136 in communication with the gateway device 134 over either wired or wireless connections. The switch 138 and AP 136 provide connectivity to the network for various client devices 140a-d.

In various embodiments, the remote site 132 may be in direct communication with primary site 102, such that client devices 140a-d at the remote site 132 access the network resources at the primary site 102 as if these clients devices 140a-d were located at the primary site 102. In such embodiments, the remote site 132 is managed by the controller 104 at the primary site 102, and the controller 104 provides the necessary connectivity, security, and accessibility that enable the remote site 132's communication with the primary site 102. Once connected to the primary site 102, the remote site 132 may function as a part of a private network provided by the primary site 102.

In various embodiments, the network configuration 100 may include one or more smaller remote sites 142, comprising only a gateway device 144 for communicating with the network 120 and a wireless AP 146, by which various client devices 150a-b access the network 120. Such a remote site 142 may represent, for example, an individual employee's home or a temporary remote office. The remote site 142 may also be in communication with the primary site 102, such that the client devices 150a-b at remote site 142 access network resources at the primary site 102 as if these client devices 150a-b were located at the primary site 102. The remote site 142 may be managed by the controller 104 at the primary site 102 to make this transparency possible. Once connected to the primary site 102, the remote site 142 may function as a part of a private network provided by the primary site 102.

The network 120 may be a public or private network, such as the Internet, or other communication network to allow connectivity among the various sites 102, 130 to 142 as well as access to servers 160a-b. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities. The network 120 may include various content servers 160a-b. Content servers 160a-b may include various providers of multimedia downloadable and/or streaming content, including audio, video, graphical, and/or text content, or any combination thereof. Examples of content servers 160a-b include, for example, web servers, streaming radio and video providers, and cable and satellite television providers. The client devices 110a-j, 140a-d, 150a-b may request and access the multimedia content provided by the content servers 160a-b.

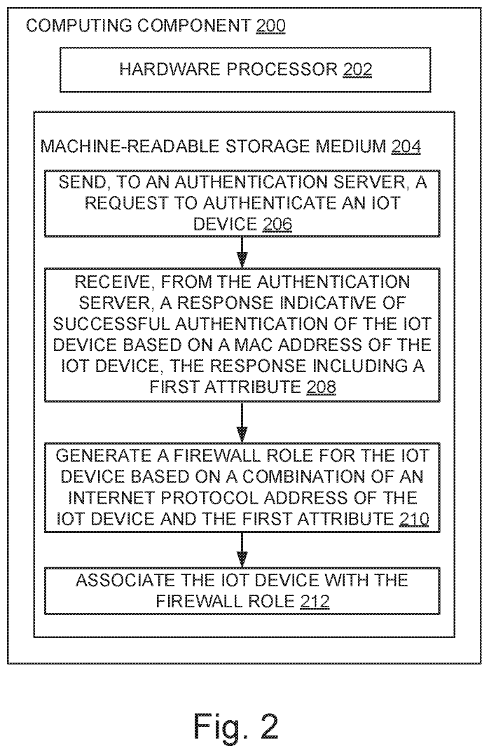

FIG. 2 is a block diagram of an example computing component or device 200 for authentication and firewall enforcement for an IoT device, in accordance with an embodiment. In an example, the computing component 200 may function as a network device, as referred to in embodiments described herein. Examples of the network device may include APs, network controllers, layer 3 switches, and routers.

In the example implementation of FIG. 2, the computing component 200 includes a hardware processor, 202, and machine-readable storage medium, 204. Hardware processor 202 may be one or more central processing units (CPUs), semiconductor-based microprocessors, and/or other hardware devices suitable for retrieval and execution of instructions stored in machine-readable storage medium, 204. Hardware processor 202 may fetch, decode, and execute instructions, such as instructions 206-212, to control processes or operations for authentication and firewall enforcement for IoT devices connecting to the computing component 200. As an alternative or in addition to retrieving and executing instructions, hardware processor 202 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 204, may be any electronic, magnetic, optical, or other physical storage device that contains or stores executable instructions. Thus, machine-readable storage medium 204 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 204 may be a non-transitory storage medium, where the term “non-transitory” does not encompass transitory propagating signals. As described in detail below, machine-readable storage medium 204 may be encoded with executable instructions, for example, instructions 206-212.

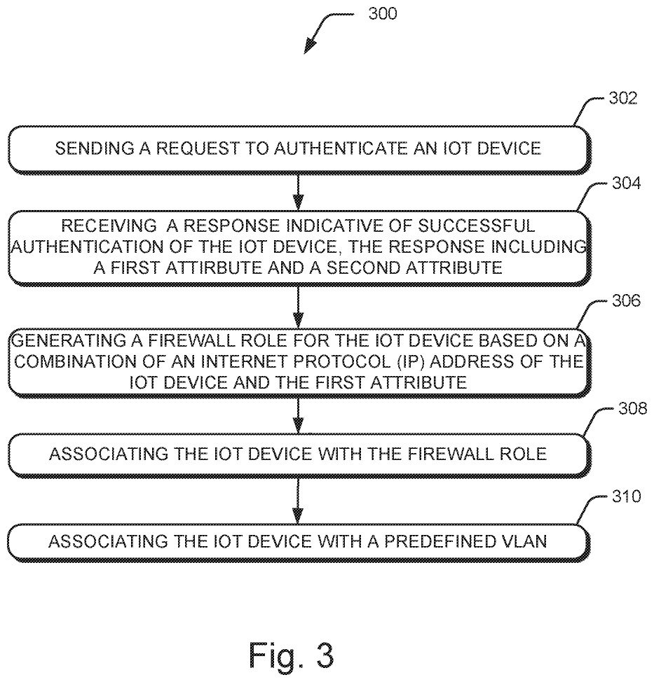

Further, although the steps shown in FIG. 2 are in an order, the shown order is not the only order in which the steps may be performed. Any step may be performed in any order, at any time, may be performed repeatedly, and/or may be performed by any suitable device or devices. The process shown in FIG. 2 is also discussed in FIG. 3, at a differing level of detail.

In step 206, the computing component 200 sends a request to authenticate an IoT device (not shown) to an authentication server. In an example, the IoT device may be an IoT USB dongle coupled to the network device through a USB port of the network device. The IoT device may have capabilities to interact with IoT sensors via low-power network protocols such as Bluetooth Low Energy (BLE), Zigbee, and the like. The IoT device may be attached to a USB port of the computing component 200 and may connect with IoT or cloud-based servers. The IoT device has a MAC address associated with it. The request to authenticate the IoT device includes the MAC address of the IoT device.

In some examples, the authentication server includes a network access management system which provides role-based and device-based secure network access control for IoT devices, as well as employees, contractors and guests across a wired, wireless and VPN infrastructure. In some examples, the authentication server may centrally manage and enforce user-based and device-based network access policies across multivendor campus and distributed network infrastructures. The authentication server may include a context-based policy manager, Remote Authentication Dial-In User Service (RADIUS) that provides centralized Authentication, Authorization, and Accounting management for users who connect and use a network service, Terminal Access Controller Access Control System (TACACS), device onboarding, and guest access options.

In an example, the request to authenticate the IoT device may be a RADIUS: Access-Request sent to a Network Access Server (NAS), for the IoT device to gain access to requested network resources. The NAS, in turn, may send the RADIUS: Access Request to the authentication server, for authentication of the IoT device to grant access via the RADIUS protocol. This request to authenticate the IoT device includes access credentials, such as a MAC address of the IoT device. Additionally, the request may contain other information about the IoT device, such as identification information (“Vendor ID and Produce ID”) of the IoT device.

In an example, the authentication server (RADIUS server) may check the access credentials, such as MAC address of the IoT device against a locally stored file database in the authentication server. In some other examples, the authentication server may refer to external sources, such as Structured Query Language (SQL), Kerberos, Lightweight Directory Access Protocol (LDAP), or Active directory servers—to verify the access credentials. In case authentication of the IoT device is unsuccessful, the authentication server may send a RADIUS: Access-Reject message to the computing component 200 thereby denying the IoT device access to all requested network resources. On successful authentication of the IoT device by the authentication server, a response indicative of successful authentication of the IoT device is sent to the computing component 200.

In step 208, the response indicative of successful authentication of the IoT device based on its MAC address is received by the computing component 200. Responsive to receiving the response, the computing component 200 grants the IoT device access to all requested network resources. The response includes a first attribute indicative of a network address of a remote server to connect with the IoT device. In an example, the first attribute is a Vendor-Specific-Attribute (VSA) included in the response. In an example, RADIUS VSAs may be carried as part of RADIUS request and response messages. The VSAs enable exchange of specific authentication, authorization, and accounting information. VSAs may allow exchange of implementation-specific information that provide extended capabilities, such as service activation or deactivation, enabling and disabling filters, and enforcing firewall roles based on information included in the VSAs.

In an example, the first attribute is determined based on a predefined mapping included in the authentication server, where the MAC address of the IoT device is linked with the first attribute. The remote server may be an IoT server or a cloud sever. In an example, the predefined mapping is preconfigured in the authentication server and associates the IoT device to a corresponding IoT server or cloud server. The IoT device may connect to the IoT server to share data from IoT sensors for processing. In an example, the predefined mapping may include a list of entries of MAC addresses of IoT devices linked to network addresses of corresponding IoT servers.

In step 210, a firewall role is generated for the IoT device based on a combination of an Internet Protocol (IP) address of the IoT device and the first attribute. In an example, the IP address is assigned to the IoT device using Dynamic Host Configuration Protocol (DHCP). In an example, responsive to receiving the response indicative of successful authentication of the IoT device, the IoT device may send a “DHCP discover” message on the network subnet. When a DHCP server in the network subnet receives the “DHCP discover” message, i.e., an IP address lease request, from the IoT device, the DHCP server reserves an IP address for the IoT device and makes a lease offer by sending a “DHCP offer” message to the IoT device. The “DHCP offer” message may contain the IoT device's MAC address, the IP address that the server is offering, the subnet mask, the lease duration, and the IP address of the DHCP server making the offer. In response to the “DHCP offer” message, the IoT device may reply with a “DHCP request” message, broadcast to the DHCP server, requesting the offered address. When the DHCP server receives the “DHCP request” message from the IoT device, the DHCP server may send a “DHCP acknowledgement” message to the IoT device. The “DHCP acknowledgement” message includes the lease duration and any other configuration information that the IoT device might have requested. Thus, an IP address gets assigned to the IoT device. In another example, a static IP address may be assigned to the IoT device based on data packets exchanged with the IoT device.

The firewall role is indicative of a permission to exchange a specific type of data traffic between the IoT device and the remote server. As explained earlier, in an example, the first attribute may include a web address of an IoT server. Once, an IP address is assigned to the IoT device, as described above, a rule or policy of data exchange may be generated using the first attribute and the IP address. In an example, such a rule or policy may be in the form of “Allow TCP traffic between <IP address> and <vendor-iot-cloud.com>”, where “<IP address>” represents the IP address assigned to the IoT device and “vendor-iot-cloud.com” represents a Universal Resource Locator (URL) of the remote server which connects to the IoT device. The firewall role includes such rule or policy, thereby restricting movement of specific traffic between a specific IoT device and a corresponding remote server.

In step 212, the generated firewall role is assigned to the IoT device coupled to the computing component 200, thereby enabling enforcement of the firewall role for data exchange with the IoT device.

FIG. 3 illustrates an example method 300 for authentication and firewall enforcement for an IoT device, accordance with an embodiment. The method 300 may be executed by a network device, such as an AP, network controller, switch, or router. In the examples described herein, it is considered that the method 300 is implemented by the network device and the IoT device is coupled to the network device via a USB port of the network device. The method 300 can be implemented by processing resource(s) or computing device(s) through any suitable hardware, a non-transitory machine readable medium, or combination thereof. In an example, the method 300 may be performed by computer-readable instructions, which include instructions stored on a medium and executable by a processing resource, such as the hardware processor 202, of a computing device/component, such as the computing component 200. Further, although the method 300 is described in context of the aforementioned computing component 200, other suitable systems may be used for execution of the method 300. It may be understood that processes involved in the method 300 can be executed based on instructions stored in a non-transitory computer-readable medium. The non-transitory computer-readable medium may include, for example, digital memories, magnetic storage media, such as a magnetic disks and magnetic tapes, hard drives, or optically readable digital data storage media.

Referring to FIG. 3, at block 302, a network device, such as one of the APs 106a-c or network controller 104 of FIG. 1, may send a request to authenticate an IoT device to an authentication server. In an example, the authentication server may be a RADIUS server and the request may be a RADIUS: Access request, as explained earlier. The IoT device may be a USB dongle device coupled to the network device through a Universal Serial Bus (USB) port of the network device. The request may include identification information, such as a MAC address, of the IoT device. In an example, when the IoT device is connected to the USB port of the network device, say AP 106a of FIG. 1, AP 106a on detecting the IoT device, may generate the RADIUS: Access request and send the RADIUS: Access request to the authentication server. In an example, the authentication server includes a central policy manager that manages authentication, authorization, and accounting of clients connecting to the AP 106a.

The authentication server may authenticate the IoT device based on its MAC address using a locally stored file database or external sources, such as Structured Query Language (SQL), Kerberos, Lightweight Directory Access Protocol (LDAP), or Active directory servers. At block 304, the network device may receive a response indicative of successful authentication of the IoT device based on the MAC address. In an example, the response may be a RADIUS: Access accept message from the authentication server. In an example, the response may include a first attribute and a second attribute, where the first and second attributes are VSAs which may be included in the response. The first attribute is indicative of a network address of a remote server, such as the servers 106a and 106b of FIG. 1, to connect with the IoT device. In an example, the IoT device may collect IoT data from IoT sensors and send such IoT data to the remote server for processing. In an example, the IoT device may exchange data with the remote server based on Transmission Control Protocol (TCP). The second attribute is indicative of a predefined Virtual Local Area Network (VLAN) for grouping the IoT device. In an example, the predefined VLAN may allow to isolate the IoT device from the rest of the WLAN infrastructure. In an example, the IoT device is authenticated based on a predefined mapping included in the authentication server. The predefined mapping links the MAC address of the IoT device with the first attribute and the second attribute. The predefined mapping may be stored locally in a file database of the authentication server or may be stored in a separate database accessible to the authentication server. An example illustration of the predefined mapping is shown in table 1 below.

TABLE 1

| IoT device MAC | IoT server address | IoT VLAN |
|---|---|---|
| 40:A3:6B:C3:20:15 | vendor-iot-cloud1.com | VLAN1 |
| 40:A3:6B:C3:20:14 | vendor-iot-cloud2.com | VLAN2 |
| 40:A3:6B:C3:20:13 | vendor-iot-cloud3.com | VLAN3 |

The authentication server may store a predefined mapping as shown in table 1, where MAC addresses of IoT devices are linked to corresponding IoT server addresses and VLANs. Although, in table 1, complete MAC addresses are mapped to IoT server address and IoT VLAN, in an example, a portion of the MAC addressed may be used in the predefined mapping. In an example, as shown in table 2 below, first four bytes of the MAC address may be used for mapping with respective IoT server address or IoT VLANs.

TABLE 2

| IoT device MAC | IoT server address | IoT VLAN |
|---|---|---|
| 40:A3:6B:C3:xx:xx | vendor-iot-cloud1.com | VLAN1 |
| 40:B8:7A:2C:xx:xx | vendor-iot-cloud2.com | VLAN2 |
| 40:A3:2B:FF:xx:xx | vendor-iot-cloud3.com | VLAN3 |

As shown in table 2, IoT devices having MAC addresses with first four bytes as “40:A3:6B:C3” are linked to IoT server address “vendor-iot-cloud1.com” and IoT VLAN “VLAN1”. Likewise, IoT devices having MAC addresses with first four bytes as “40:B8:7A:2C” are linked to IoT server address “vendor-iot-cloud2.com” and IoT VLAN “VLAN2” and IoT devices having MAC addresses with first four bytes as “40:A3:2B:FF” are linked to IoT server address “vendor-iot-cloud3.com” and IoT VLAN “VLAN3”. Thus, the predefined mapping may be based on the MAC address of the IoT device or a portion thereof.

Referring to table 1, when IoT device having MAC address “40:A3:6B:C3:20:15” is connected to a network device, such as the AP 106a, the network device sends a request to the authentication server with the MAC address “40:A3:6B:C3:20:15” and based on the MAC address, the authentication server validates the IoT device and sends a response indicative of successful authentication of the IoT device. The response includes the IoT server address “vendor-iot-cloud1.com” as the first attribute and IoT VLAN information “VLAN1” as the second attribute. In an example, the predefined mapping may be configured in the authentication server and may specify the “IoT server address” and “IoT VLAN” corresponding to each IoT device. In an example, as shown in table 2, a portion of the MAC address of the IoT devices may be specified in the pre-defined mapping and the IoT devices may be authenticated based on a portion of the MAC address.

At block 306, a firewall role is generated for the IoT device based on a combination of an Internet Protocol (IP) address of the IoT device and the first attribute. In an example, the IP address of the IoT device may be assigned based on DHCP. In another example, the IP address may be a static IP address. The firewall role is indicative of a permission to exchange a specific type of data traffic between the IoT device and the remote server. With reference to table 1, consider that the IoT device having MAC address 40:A3:6B:C3:20:15 is assigned an IP address 162.18.252.1. In an example, based on the mapping of table 1, the firewall role for the IoT device may be generated as “Allow TCP traffic between 162.18.252.1 and vendor-iot-cloud1.com”. Thus, based on the IP address and the first attribute the firewall role is generated. At block 308, the IoT device is associated with the generated firewall role. Association of the IoT device with the firewall role includes controlling data traffic to and from the IoT device based on the policies or rules defined in the generated firewall role.

At block 310, the IoT device is associated with the predefined VLAN as mentioned in the second attribute included in the response from the authentication server. Association of the IoT device includes grouping the IoT device under the predefined VLAN. Association with the predefined VLAN, enables monitoring performance characteristics of the IoT device. In an example, based on the VLAN identification (ID) in which the IoT device is grouped, the authentication server may monitor management and telemetry information associated with the IoT device.

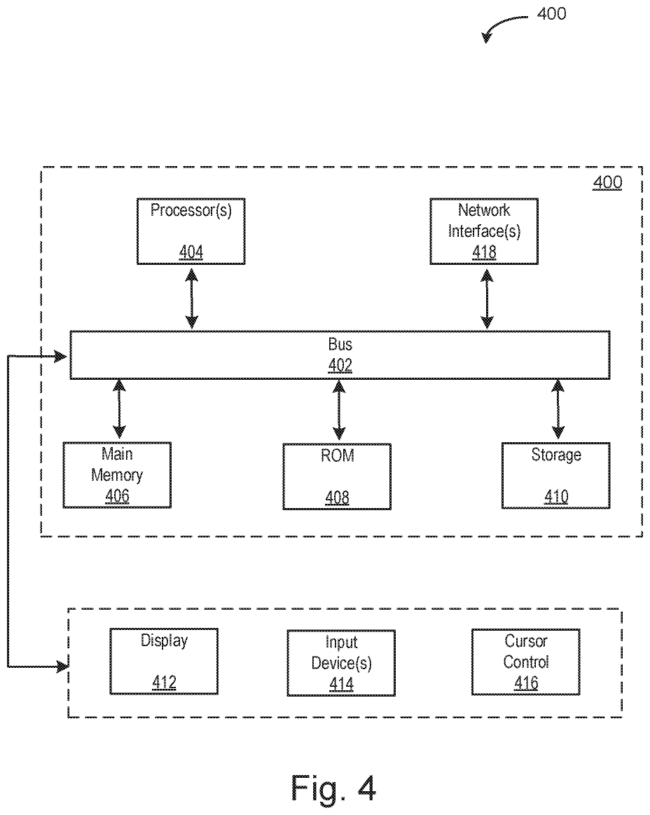

FIG. 4 depicts a block diagram of an example computer system 400 in which the embodiments described herein may be implemented. The computer system 400 includes a bus 402 or other communication mechanism for communicating information, one or more hardware processors 404 coupled with bus 402 for processing information. Hardware processor(s) 404 may be, for example, one or more general purpose microprocessors.

The computer system 400 also includes a main memory 406, such as a random access memory (RAM), cache and/or other dynamic storage devices, coupled to bus 402 for storing information and instructions to be executed by processor 404. Main memory 406 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions.

The computer system 400 further includes a read only memory (ROM) 408 or other static storage device coupled to bus 402 for storing static information and instructions for processor 404. A storage device 410, such as a magnetic disk, optical disk, or USB thumb drive (Flash drive), etc., is provided and coupled to bus 402 for storing information and instructions.

The computer system 400 may be coupled via bus 402 to a display 412, such as a liquid crystal display (LCD) (or touch screen), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. In some embodiments, the same direction information and command selections as cursor control may be implemented via receiving touches on a touch screen without a cursor.

The computing system 400 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Per, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor(s) 404 executing one or more sequences of one or more instructions contained in main memory 406. Such instructions may be read into main memory 406 from another storage medium, such as storage device 410. Execution of the sequences of instructions contained in main memory 406 causes processor(s) 404 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 410. Volatile media includes dynamic memory, such as main memory 406. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 402. Transmission media can also take the form of acoustic or light waves, such as those generated during radio-wave and infra-red data communications.

The computer system 400 also includes a communication interface 418 coupled to bus 402. Network interface 418 provides a two-way data communication coupling to one or more network links that are connected to one or more local networks. For example, communication interface 418 may be an integrated services digital network (ISDN) card, cable modem, satellite modem, or a modem to provide a data communication connection to a corresponding type of telephone line. As another example, network interface 418 may be a local area network (LAN) card to provide a data communication connection to a compatible LAN (or WAN component to communicated with a WAN). Wireless links may also be implemented. In any such implementation, network interface 418 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 418, which carry the digital data to and from computer system 400, are example forms of transmission media.

The computer system 400 can send messages and receive data, including program code, through the network(s), network link and communication interface 418. In the Internet example, a server might transmit a requested code for an application program through the Internet, the ISP, the local network and the communication interface 418. The received code may be executed by processor 404 as it is received, and/or stored in storage device 410, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 400.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

Although implementations of present subject matter have been described in language specific to structural features and/or methods, it is to be noted that the present subject matter is not necessarily limited to the specific features or methods described. Rather, the specific features and methods are disclosed and explained in the context of a few implementations for the present subject matter.

We claim:

1. A method for authentication and firewall enforcement for an Internet of Things (IoT) device coupled to a network device, the method comprising:
sending, by the network device to an authentication server, a request to authenticate the IoT device, the request including a Media Access Control (MAC) address of the IoT device;
receiving, by the network device from the authentication server, a response indicative of successful authentication of the IoT device based on the MAC address, wherein the response includes a first attribute indicative of a network address of a remote server to connect with the IoT device;
generating, by the network device, a firewall role for the IoT device based on a combination of an Internet Protocol (IP) address of the IoT device and the first attribute; and
associating, by the network device, the IoT device with the firewall role.

2. The method of claim 1, wherein the firewall role is indicative of a permission to exchange a specific type of data traffic between the IoT device and the remote server.

3. The method of claim 1, wherein the response includes a second attribute indicative of a predefined Virtual Local Area Network (VLAN) for grouping the IoT device.

4. The method of claim 3, further comprising:
associating, by the network device, the IoT device with the predefined VLAN; and
monitoring, by the network device, performance characteristics of the IoT device based on the association with the predefined VLAN.

5. The method of claim 3, wherein the IoT device is authenticated based on a predefined mapping included in the authentication server, and wherein the predefined mapping links the MAC address of the IoT device with the first attribute and the second attribute.

6. The method of claim 3, wherein the first and second attributes are Vendor-specific attributes included in the response.

7. The method of claim 1, wherein the request is a Remote Authentication Dial-In User Service (RADIUS): Access-Request message and the response is a RADIUS: Access-Accept message.

8. The method of claim 1, wherein the IoT device is an IoT dongle coupled to the network device through a Universal Serial Bus (USB) port of the network device.

9. The method of claim 1, wherein the IP address is assigned to the IoT device using Dynamic Host Configuration Protocol (DHCP).

10. An access point (AP) comprising:
a processor; and
a memory coupled to the processor, the memory storing instructions executable by the processor to:
send, to an authentication server, a request to authenticate an IoT device coupled to the AP, the request including a Media Access Control (MAC) address of the IoT device;
receive, from the authentication server, a response indicative of successful authentication of the IoT device based on the MAC address, wherein the response includes a first attribute indicative of a network address of a remote server to connect with the IoT device;
generate a firewall role for the IoT device based on a combination of an Internet Protocol (IP) address of the IoT device and the first attribute; and
associate the IoT device with the firewall role.

11. The access point of claim 10, wherein the firewall role is indicative of a permission to exchange a specific type of data traffic between the IoT device and the remote server.

12. The access point of claim 10, wherein the response includes a second attribute indicative of a predefined Virtual Local Area Network (VLAN) for grouping the IoT device.

13. The access point of claim 12, wherein the processor is further to:
associate the IoT device with the predefined VLAN; and
monitor performance characteristics of the IoT device based on the association with the predefined VLAN.

14. The access point of claim 12, wherein the IoT device is authenticated based on a predefined mapping included in the authentication server, and wherein the predefined mapping links the MAC address of the IoT device with the first attribute and the second attribute.

15. The access point of claim 10, wherein the request is a Remote Authentication Dial-In User Service (RADIUS): Access-Request message and the response is a RADIUS: Access-Accept message.

16. A non-transitory computer-readable medium comprising computer-readable instructions, the computer-readable instructions when executed by a processor, cause the processor to:
send, to an authentication server, a request to authenticate an IoT device coupled to the AP, the request including a Media Access Control (MAC) address of the IoT device;
receive, from the authentication server, a response indicative of successful authentication of the IoT device based on the MAC address, wherein the response includes a first attribute indicative of a network address of a remote server to connect with the IoT device;
generate a firewall role for the IoT device based on a combination of an Internet Protocol (IP) address of the IoT device and the first attribute; and
associate the IoT device with the firewall role.

17. The non-transitory computer-readable medium of claim 16, wherein the firewall role is indicative of a permission to exchange a specific type of data traffic between the IoT device and the remote server.

18. The non-transitory computer-readable medium of claim 16, wherein the response includes a second attribute indicative of a predefined Virtual Local Area Network (VLAN) for grouping the IoT device.

19. The non-transitory computer-readable medium of claim 18, wherein the computer-readable instructions, when executed by the processor, further cause the processor to:
associate the IoT device with the predefined VLAN; and
monitor performance characteristics of the IoT device based on the association with the predefined VLAN.

20. The non-transitory computer-readable medium of claim 18, wherein the IoT device is authenticated based on a predefined mapping included in the authentication server, and wherein the predefined mapping links the MAC address of the IoT device with the first attribute and the second attribute.
